(19) United States
(12) Patent Application Publication
(10) Pub. No.: US 2003/0040396 A1
(43) Pub. Date: Feb. 27, 2003

(54) Gear drive assembly

(75) Inventors: Darryl Berlinger, Doylestown, PA (US); John W. Cross, Collegeville, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: ASI Technologies, Inc.

(21) Appl. No.: 10/278,128

(22) Filed: Oct. 21, 2002

Related U.S. Application Data
(63) Continuation-in-part of application No. 09/916,623, filed on Jul. 27, 2001.
(60) Provisional application No. 60/339,973, filed on Oct. 26, 2001.

(51) Int. Cl. F16H 48/08

(52) U.S. Cl. 475/230

(57) ABSTRACT

A gear drive assembly includes an elongated housing with a cavity and a pair of opposed apertures in communication with the cavity. At least one output shaft extends through the apertures. A drive gear is positioned in the cavity and fixedly connected to the at least one output shaft for rotation therewith. The drive gear and the output shaft have a predefined range of travel in a direction of the longitudinal axis to facilitate assembly of the gear drive assembly. A spacer is located within the cavity between the housing and the drive gear and is configured to preclude movement of the drive gear and the output shaft through the predefined range of travel after assembly. A drive motor can be mounted on the housing for transferring power to the at least one output shaft. A bearing and seal assembly is mounted in the housing around the drive shaft of the drive motor and an axial spacer is located between the drive motor and the bearing and seal assembly to thereby prevent movement of the bearing and seal assembly. A variable length mount can be located at a longitudinal end of the housing. The mount may be shortened to accommodate various mounting criteria of a vehicle.

### CROSS-REFERENCE TO RELATED APPLICATIONS

This application is a continuation-in-part of U.S. patent application Ser. No. 09/916,623 filed on Jul. 27, 2001, the disclosure of which is hereby incorporated by reference in its entirety. This application also claims the benefit of U.S. Provisional Application No. 60/339,973 filed on Oct. 26, 2001, the disclosure of which is also hereby incorporated by reference in its entirety.

### BACKGROUND OF THE INVENTION

The present invention relates in general to gear assemblies and in particular to an adaptive length gear assembly housing which is configurable for a variety of applications and a spacer assembly for improving durability and reliability of gear assemblies and facilitating their construction.

Gear drive systems relevant to the present invention typically are used in motorized vehicles, such as automobiles or golf carts, which have left-side and right-side driving wheels. In such applications, the gear drive system is positioned within a housing and receives power from a motor or other power source via an input shaft connected to the gear drive system. The input shaft transfers that power through the gear system and to output shaft(s) attached to each of the left- and right-side driving wheels. One example of such gear drive systems is a differential gear assembly used in a transaxle of, for instance, a golf cart. The differential gear assembly divides power between the left- and right-side driving wheels and permits these two wheels to rotate at different speeds when the vehicle turns.

Differential gear assemblies generally are complex structures having many interrelated parts that must be assembled within one or more housings. Thus, assembling and disassembling these structures can be time consuming and, when assembled in mass-production fashion, even incremental increases in time-efficiency can provide significant benefit. Further, as one would expect, keeping a large number of parts on-hand for construction of gear assemblies is an inefficient use of capital, particularly when many of the parts will not be used in every gear assembly but are used only when a particular configuration is required. These considerations are significant even for non-differential gear assemblies. An example of one such non-differential gear assembly is a transaxle having a “straight” or single axle that extends between a pair of opposed driving wheels wherein a drive gear is non-rotatably fixed to the single axle by a retainer, usually a key/keyway feature. By configuring parts for these and other gear assemblies so that they may have application in more than one model gear assembly, inventory costs are reduced, as are tooling costs.

In certain applications as, for example, gear assemblies for golf carts, it is often the case that the working parts, i.e., the gears themselves, remain constant from one type or model vehicle to the next. However, equally often, different types or models of vehicles will require different external configuration of the gear assembly housing. In this regard, the housing within which the gears and shafts are located often must be either longer or shorter to accommodate different vehicle configurations. The drawback to this is that a manufacturer of gear assemblies for such vehicles must keep on hand several different housings, each having a different length, merely to accommodate these different vehicles. Significantly, although it has been possible to maintain consistency in virtually every aspect of housing design, housings of various lengths must be kept in inventory in the event longer or shorter housings become necessary for a given application.

The present invention overcomes the difficulties presented by prior art single-length housings by providing a housing that has adaptive length and can be modified for various applications.

Further, inasmuch as it is desirable to facilitate construction of gear assemblies by reducing the number of parts and assembly steps while improving reliability and durability, the present invention provides for ensuring that bearings and seals remain in place without sacrificing assembly time.

It should be understood that the present invention is intended to have application in all differential and non-differential gear drive systems that are positioned within housings.

### BRIEF SUMMARY OF THE INVENTION

According to one aspect of the invention, a gear drive assembly comprises an elongated housing with a cavity and a pair of opposed apertures in communication with the cavity. The apertures are aligned with a longitudinal axis of the housing. A first output shaft extends through one of the apertures and has a first inboard end located within the cavity. A second output shaft extends through the other of the apertures and has a second inboard end located within the cavity. The first and second output shafts are at least substantially aligned with the longitudinal axis. A first gear is fixedly connected to the first inboard end of the first output shaft for rotation therewith. A second gear is fixedly connected to the second inboard end of the second output shaft for rotation therewith. At least the second gear and the second output shaft have a predefined range of travel in a direction of the longitudinal axis to facilitate assembly of the gear drive assembly. A spacer is located within the cavity between the housing and the second gear. The spacer is configured to preclude movement of the second gear and the second output shaft through at least substantially all of the predefined range of travel.

According to a further aspect of the invention, a gear drive assembly comprises an elongated housing with a cavity and a pair of opposed apertures in communication with the cavity. The apertures are aligned with a longitudinal axis of the housing. An output shaft extends through the apertures. A drive gear is positioned in the cavity and fixedly connected to the output shaft for rotation therewith. The drive gear and the output shaft have a predefined range of travel in a direction of the longitudinal axis to facilitate assembly of the gear drive assembly. A spacer is located within the cavity between the housing and the drive gear. The spacer is configured to preclude movement of the drive gear and the output shaft through at least substantially all of the predefined range of travel.

According to an even further aspect of the invention, a gear drive assembly comprises an elongated housing with a cavity and a pair of opposed apertures in communication with the cavity. The apertures are aligned with a longitudinal axis of the housing. At least one output shaft extends through the apertures. A drive gear is positioned in the cavity and fixedly connected to the at least one output shaft for rotation therewith. A drive motor is mounted on the housing and operably connected to the at least one gear for transferring power from the drive motor to the at least one output shaft. The drive motor includes a drive shaft. A bearing and seal assembly is mounted in the housing around the drive shaft. An axial spacer is located between, and in contact with, the drive motor and the bearing and seal assembly to thereby prevent movement of the bearing and seal assembly.

According to yet a further aspect of the invention, a housing for a gear drive assembly comprises a bottom wall extending along a longitudinal axis, a pair of opposing side walls extending from the bottom wall along the longitudinal axis, a top wall opposite the bottom wall and connected to the pair of opposing side walls along the longitudinal axis, and a pair of opposing end walls extending between the top, bottom and side walls generally transverse to the longitudinal axis. The bottom, side, top, and end walls form an internal cavity into which a gear drive assembly can be received. An aperture is formed in each end wall in alignment with the longitudinal axis. The apertures are adapted for receiving at least one shaft of the gear drive assembly. At least one of the end walls is variable in position along the longitudinal axis to accommodate various mounting criteria of a vehicle.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a partial, top plan view of a transaxle, partly broken away, showing an exemplary differential gear assembly and spacer in accordance with a preferred embodiment of the present invention;

FIG. 2 is a front elevational view of the spacer shown in FIG. 1;

FIG. 3 is a top plan view of the spacer shown in FIG. 1;

FIG. 4 is a rear elevational view of the spacer shown in FIG. 1;

FIG. 5 is a bottom plan view of a cover for the transaxle housing shown in FIG. 1;

FIG. 6 is a side elevation view of the cover shown in FIG. 5;

FIG. 7 is a front elevational view of a first alternative embodiment of the spacer;

FIG. 8 is a top plan view of the spacer shown in FIG. 7;

FIG. 9 is a bottom plan view of the spacer shown in FIG. 7;

FIG. 10 is a left side (with reference to the view of FIG. 7) elevational view of the spacer shown in FIG. 7;

FIG. 11 is a rear elevational view of the spacer shown in FIG. 7;

FIG. 12 is a partial, top plan view of a transaxle, partly broken away, showing an exemplary non-differential gear assembly and spacer in accordance with a further preferred embodiment of the present invention;

FIG. 13 is side elevational view of an alternative embodiment of the transaxle housing of FIG. 1;

FIG. 14 is a bottom plan view of the housing of FIG. 13;

FIG. 15 is a side elevational view of a second alternative embodiment of the transaxle housing of FIG. 1;

FIG. 16 is a side elevational view, taken in cross-section, of the housing of FIG. 13, including the exemplary differential gear assembly of FIG. 1;

FIG. 17 is an enlarged view of the input portion of the exemplary differential gear assembly of FIG. 16;

FIG. 18 is a perspective view of the preferred embodiment of an axial spacer of the exemplary differential gear assembly of FIG. 16;

FIG. 19 is a partial side plan view, taken in cross-section, of a second alternative embodiment of the transaxle housing of FIG. 1;

FIG. 20 is a side elevational view of the second alternative embodiment of the transaxle housing shown in FIG. 19, taken along line 20-20 of FIG. 19;

FIG. 21 is a perspective view of an alternative embodiment of an axial spacer of the exemplary differential gear assembly of FIG. 16; and

FIG. 22 is a side elevational view of the alternative embodiment of an axial spacer of the exemplary differential gear assembly of FIG. 16.

### DETAILED DESCRIPTION OF THE INVENTION

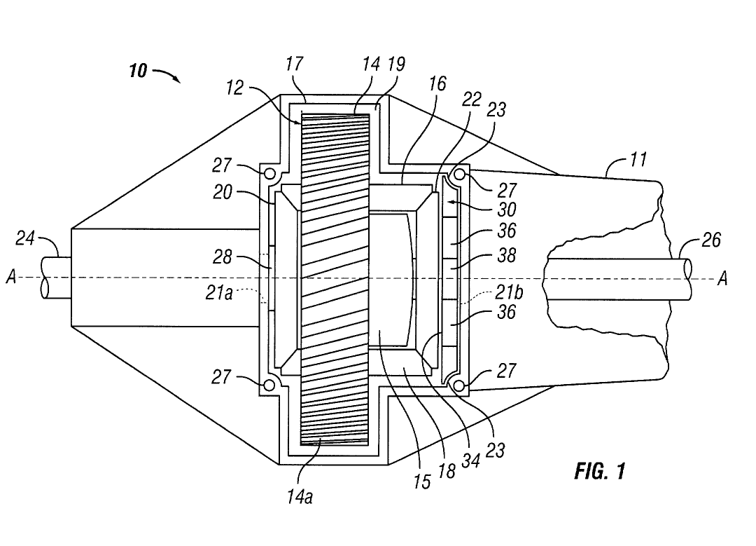

Referring to FIG. 1, there is shown a differential gear drive system, generally designated 10, having a housing 11 and a differential gear assembly 12 situated within the housing 11. The differential gear assembly 12 is of a type well known to those skilled in the art and is intended herein to be illustrative and is not intended to limit the present invention solely to differential gear drive systems or to precisely the type of differential gear drive system shown.

The differential gear assembly 12 resides within a housing 11, and in particular within a cavity 19 within the housing 11. The housing 11 includes a service port 17 in communication with the cavity 19 to provide access to the cavity 19, thereby facilitating assembly of the transaxle 10, as described in detail below.

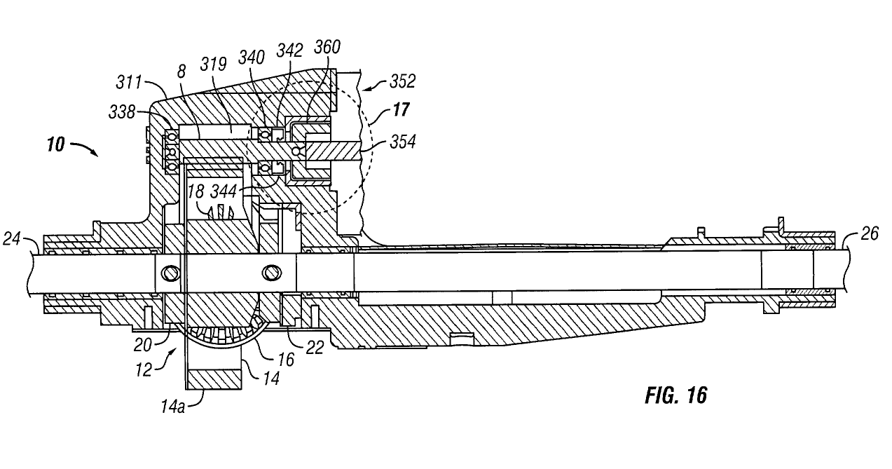

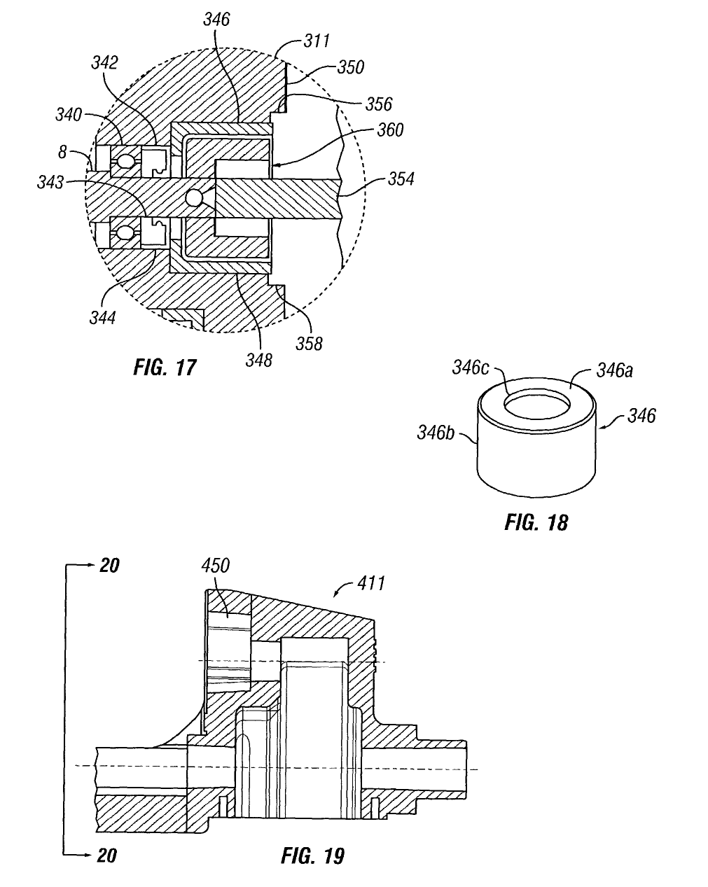

The differential gear assembly 12 preferably includes an input shaft/pinion gear 8 (see FIGS. 16, 17) drivingly engaged with a primary helical gear 14 which rotates about an axis A-A passing longitudinally through the housing 11. The primary helical gear 14 includes a plurality of helical gear teeth 14a, a central support structure 15, preferably unitary with the primary helical gear 14, and through which is a central bore (not shown), and a pair of transverse passages (not shown) which pass through the primary helical gear 14 and which receive an opposing pair of rotating, orbiting bevel gears 16, 18. The orbiting bevel gears 16, 18 rotate about axes which are perpendicular to axis A-A on mounting shaft assembles (not shown), the ends of which are slidably mounted in transverse slots (not shown) in communication with the transverse passages through the primary helical gear 14. Thus, the orbiting bevel gears 16, 18 rotate about their individual axes, while rotating about axis A-A, and are slidable transversely in the direction of axis A-A.

The orbiting bevel gears 16, 18 are drivingly engaged to first and second bevel gears 20, 22. The first and second bevel gears 20, 22 preferably are non-rotatingly and removably fixed to the inboard end of each of first and second output shafts 24, 26, respectively. It should be noted that the inboard ends of the first and second output shafts 24, 26 are, upon assembly of the differential gear drive system 10, positioned within the cavity 19. Thus, the first and second bevel gears 20, 22 are located within the cavity 19, and are in operative engagement with the differential gear assembly 12, the gear assembly 12 transferring power to the first and second output shafts 24, 26 via the first and second bevel gears 20, 22.

To accommodate the first and second output shafts 24, 26, the housing 11 includes a pair of opposed, axially aligned apertures 21a, 21b in communication with the cavity 19. The first output shaft 24 is positioned in a first aperture 21a, whereas the second output shaft 26 is positioned in a second aperture 21b. The first and second output shafts 24, 26 preferably are at least substantially aligned along their longitudinal axes. In other words, their alignment is preferably parallel and co-axial along the longitudinal axes, but may vary somewhat to accommodate design changes that, for example, may be required for particular applications.

The first and second bevel gears 20, 22, are non-rotatingly and removably fixedly to the first and second output shafts 24, 26 by a locator cross pin (not shown) which passes slidably and transversely through the first output shaft 24 adjacent to the inboard end of the first output shaft 24 and through the second output shaft 26 at a point preferably spaced from the inboard end of the second output shaft 26 (for reasons that will become apparent below). The locator cross pins are received by a slot (not shown) in an outboard side of each of the first and second bevel gears 20, 22, thus preventing rotation of the first and second bevel gears 20, 22 relative to the first and second output shafts 24, 26, respectively. It will be understood by those skilled in the art that the first and second bevel gears 20, 22 may be rotationally fixed to the first and second output shafts 24, 26, and yet removable therefrom, by any of a number of well-known devices, such as by keyways, pins, mating threads, etc. Additionally, depending on the nature of the housing 11 used, i.e., whether the housing 11 is split longitudinally (not shown), the first and second bevel gears 20, 22 may be permanently fixed to the first and second output shafts 24, 26 without departing from the scope and spirit of the invention.

Each of the first and second output shafts, 24, 26 preferably is slidably (in the direction of longitudinal axis A-A) and rotatably mounted in the housing 11, primarily to permit assembly of the above-described differential gear assembly 12, as will be discussed in detail below. As will be recognized by those skilled in the art, the locator cross pin which passes through the second output shaft 26 is spaced from the inboard end of the shaft 26 to permit the second output shaft 26 to extend through a central passage (not shown) through the primary helical gear 14, which is rotatably mounted on, and supported in part by, the inboard end of the second output shaft 26. Therefore, given the nature of the housing 11 as unitary, i.e., not being separable into discrete sections along a plane perpendicular to axis A-A, at least one of the first and second output shafts 24, 26, and accordingly, the first and second bevel gears 20, 22, preferably are slidably movable within the housing 11 in the direction of axis A-A (and in the direction of the longitudinal axes of the first and second output shafts 24, 26). Alternatively to the above-described configuration, it is also contemplated that only one of the first and second output shafts 24, 26 be slidably movable in the direction of axis A-A, and that the slidable output shaft may be either the first or the second output shaft 24, 26. Those skilled in the art will recognize that changes of this nature to the above-described structure are primarily determined by the nature of the housing 11 employed (i.e., whether the housing 11 is a unitary or separable structure and how the components within the housing 11 are installed) and the nature of the gears used in the transaxle 10. It will be recognized that changes of this nature are well within the capabilities of one skilled in the art.

Preferably, the primary helical gear 14, orbiting bevel gears 16, 18, first and second bevel gears 20, 22, and first and second output shafts 24, 26 are made from metallic materials, most preferably steel. However, it is contemplated that these components may also be constructed of polymeric material or other high-strength, durable material without departing from the spirit and scope of the invention.

As those skilled in the art will recognize, proper alignment (along axis A-A) and engagement of the bevel gears 16, 18, 20, 22 is required for efficient operation and longevity of the differential gear drive system 10. In that vein, proper spacing of the first and second bevel gears 20, 22 with respect to one another is essential. The first bevel gear 20 is properly positioned along axis A-A on its outboard side by a first circumferential bearing or washer 28 which is positioned on the first output shaft 24 between the housing 11 and the outboard side of the first rotating bevel gear 20. On its inboard side, the first bevel gear 20 is properly positioned by its engagement with the orbiting bevel gears 16, 18. Thus, the axial movement of the first bevel gear 20 in the direction of axis A-A is constrained on one side by the first spacing washer 28 and on its opposite side by the orbiting bevel gears 16, 18.

The orbiting bevel gears 16, 18, and accordingly the primary helical gear 14, are properly axially positioned along axis A-A by engagement of the orbiting bevel gears 16, 18 with the first and second bevel gears 20, 22. Accordingly, in the preferred configuration described herein, proper positioning of the second bevel gear 22 along axis A-A is essential to the proper alignment and engagement of the remainder of the gear assembly 12. Recall, however, that as stated above, in alternative embodiments, either or both of the first and second output shafts 24, 26 (and accordingly, first and second bevel gears 20, 22) may be slidable in the direction of axis A-A to facilitate assembly and therefore, depending on whether an alternative embodiment is employed, proper positioning of the orbiting bevel gears 16, 18 and primary helical gear 14 may be determined by either or both of the first and second bevel gears 20, 22.

Referring again to FIG. 1, the position of the second bevel gear 22 along the longitudinal axis A-A is maintained on its inboard side by engagement with the orbiting bevel gears 16, 18 which themselves are positioned by engagement with the first rotating bevel gear 20. The advance of the present invention is related to the apparatus for maintaining positioning of the orbiting bevel gears 16, 18 and primary helical gear 14 through proper positioning of one of the first and second bevel gears 20, 22, and most preferably the second bevel gear 22. Such positioning preferably is obtained from affecting positioning of the second bevel gear 22 from the outboard direction, i.e., between the second bevel gear 22 and the housing 11. It is well known to those skilled in the art that, given the configuration of the housing 11 of the preferred embodiment, at least one of the first and second bevel gears 20, 22, and most preferably the second bevel gear 22, must have significant axial movement (in the longitudinal direction A-A) to permit assembly of the differential gear assembly 12, as will be discussed in more detail below. This longitudinal movement of the second bevel gear 22 permits the first bevel gear 20 and the gear assembly 12 consisting of the primary helical gear 14 and the orbiting bevel gears 16, 18 to be positioned within the housing 11 during assembly without the need to have a break (not shown) through the entire housing 11 in a plane perpendicular to the axis A-A that would permit splitting of the housing 11 (commonly referred to as a “clamshell housing”). In other words, the axial movement of the second rotating bevel gear 22 and the second output shaft 26 is achieved not through splitting the housing 11 as described above, but rather by designing the cavity 19 of the housing 11 with sufficient space to permit axial movement of, preferably, the second bevel gear 22 to allow insertion of the locator cross pin which engages the outboard side of the bevel gear 22. The additional space within the housing 11 is shown in FIG. 1 as being occupied by a preferred embodiment of a slip-in spacer 30. Preferably, the spacer 30 is constructed of aluminum, but it is contemplated that the spacer 30 could be made from any material, such as a polymeric material, that maintains its shape under a variety of operating conditions.

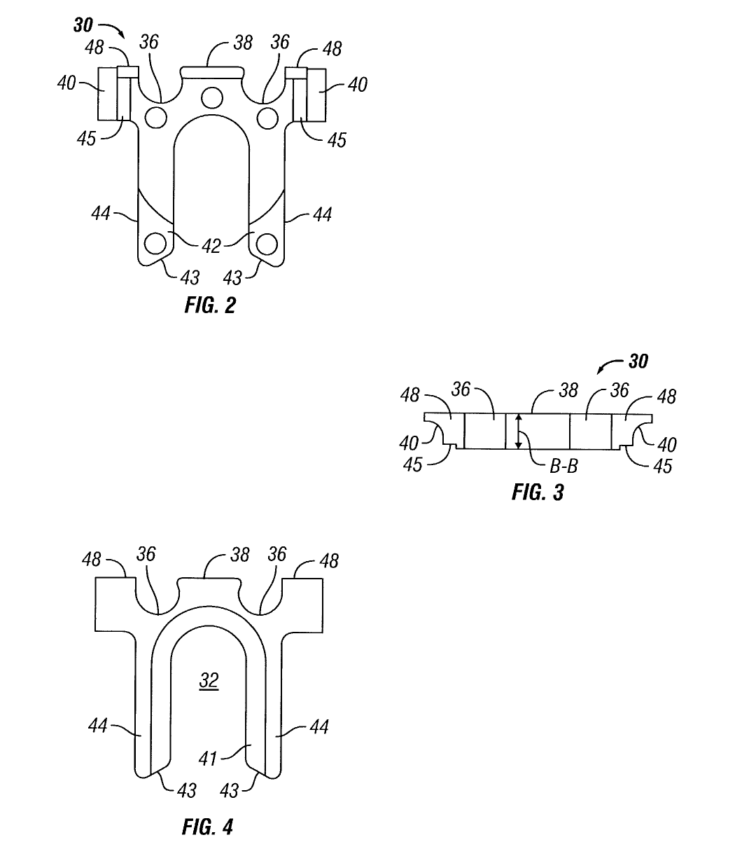

The spacer 30 of the preferred embodiment, best shown in FIGS. 1-4, is positioned proximate the service port 17, between the outboard side of the second bevel gear 22 and the housing 11 as shown in FIG. 1, such that the second output shaft 26 passes through the spacer 30. Again note that the spacer 30 may be employed to properly space either or both of the first and second bevel gears 20, 22 from the housing 11 to achieve proper alignment of the various components of the transaxle 10. The outboard side (shown in FIG. 2) of the spacer 30 engages the housing 11 and is preferably spaced from the outboard side of the second bevel gear 22 by a second circumferential bearing or washer 34 which, as will be recognized by those skilled in the art, provides a bearing surface against which the second bevel gear 22 rotates, thus reducing wear of the second bevel gear 22 and the spacer 30. As will further be recognized by those skilled in the art upon reading this disclosure, the second rotating bevel gear 22 is held in mating engagement with the orbiting bevel gears 16, 18 by engagement between the outboard side of the second bevel gear 22 and the second washer 34, the second washer 34 and the spacer 30, and the spacer 30 and the housing 11. The spacer 30 is thus configured and functions to preclude movement of the second output shaft 26 and second bevel gear 22 through at least substantially all the predefined range of travel in the direction of axis A-A and the longitudinal axes of the first and second output shafts 24, 26. In other words, the spacer 30 takes up most if not all of the movement of the first and/or second output shafts 24, 26 that is designed to facilitate assembly of the transaxle 10. To this end, the spacer 30 preferably has a thickness (in the direction of axis A-A) approximately equal to the predefined range of travel.

The spacer 30 of the preferred embodiment preferably includes a slot 32, the second output shaft 26 preferably passing through the spacer 30 via the slot 32. As will be recognized by those skilled in the art from reading this disclosure, using a slot 32 rather than a hole for passing the second output shaft 26 through the spacer 30 permits the spacer 30 to be slipped into the housing 11 between the second washer 34 and the housing 11, thus facilitating rapid assembly of the transaxle 10. The spacer 30 is further provided with a pair of recesses 36 which define a finger grip 38 to facilitate installation and removal of the spacer 30 from the housing 11 during assembly/disassembly and repair. The spacer 30 preferably includes a pair of legs 44 which define the slot 32. Additionally, the spacer 30 is provided with a pair of inclined surfaces 43 along the lead edges of the legs 44 sloping inwardly from the outboard surfaces of the legs 44 toward the slot 32 to facilitate placing the spacer 30 between the second washer 34 and the housing 11. The gear-side (shown in FIG. 4) of the spacer 30 preferably is provided with a recess 41 along the periphery of the slot 32 to accommodate the second circumferential bearing or washer 34. The recess 41 is not critical to the proper functioning of the spacer 30 inasmuch as the second washer 34 may seat directly against the inboard side of the spacer 30, or, depending on the material from which the spacer 30 is made, may be integral with the spacer 30 without departing from the spirit and scope of the invention. It should be noted that the recess 41, in addition to other external features of the spacer 30, assists in properly orienting the spacer 30 within the housing 11.

Referring to FIGS. 2-4, the spacer 30 preferably is provided with features to accommodate corresponding features within the interior of the housing 11. These features include a pair of fillets 40 on each lateral side of the spacer 30 to accommodate screw bosses 23 within the cavity 19 of the housing 11. Additionally, the spacer 30 preferably includes first and second rabbets 42, 45 to prevent interference between any imperfections in the inner corners of the casting of the housing 11 and the spacer 30. It should be noted that the configuration of outer surfaces of the spacer 30 may play an important role in preventing the spacer from spinning freely in the housing 11 and also preventing the improper positioning of spacer 34 in the housing 11.

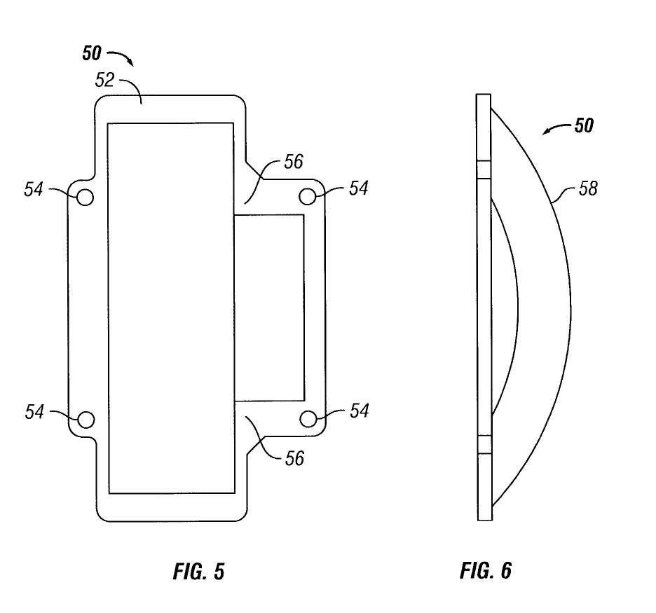

In prior art configurations (not shown), proper positioning along the A-A axis was obtained through the use of a split spacer (not shown) which required one to fasten two segments together such that they would be retained in a position to maintain the proper positioning of the first and second output shafts 24, 26. By contrast, the spacer 30 is retained within the housing 11 by contact preferably between the contact surfaces 48 of the spacer 30 and a cover 50, shown in FIGS. 5 and 6. The cover 50 is fixed to the housing 11 over the service port 17 of the housing 11, thereby sealing the cavity 19, thus protecting the gear assembly 12 and retaining the spacer 30. The cover 50 preferably includes a mounting flange 52 which engages the housing 11. A plurality of non-threaded holes 54 in the mounting flange 52 correspond with a plurality of threaded holes 27 in the housing 11 such that the cover 50 may be secured to the housing 11 by a plurality of fasteners (not shown). Alternatively, the cover 50 could be fastened to the housing 11 by any of a number of alternative ways known to those skilled in the art such as by clamping, use of adhesives, welding, etc. The cover 50 retains the spacer 30 within the housing 11 by proximity between a pair of contact surfaces 48 on the spacer 30 and a corresponding pair of lands 56 on the cover 50. It will be recognized by those skilled in the art that in the preferred embodiment, the lands 56 and contact surfaces 48 need only be proximate to one another, and that the lands 56 and contact surfaces 48 need not always be in contact, so long as the spacer 30 is restrained from moving out of position. Thus, when the cover 50 is fixed to the housing 11, the spacer 30 is retained in position and obviates the need to use a two-piece spacer (not shown) as was used in the prior art. Preferably, the cover 50 is also provided with a raised profile 58 to accommodate the outer profile of the differential gear assembly 12.

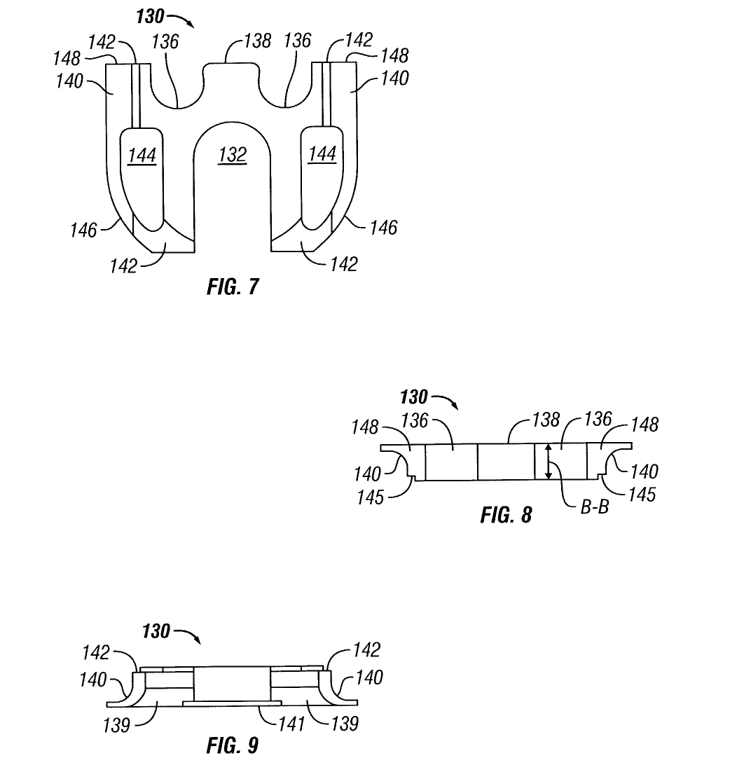

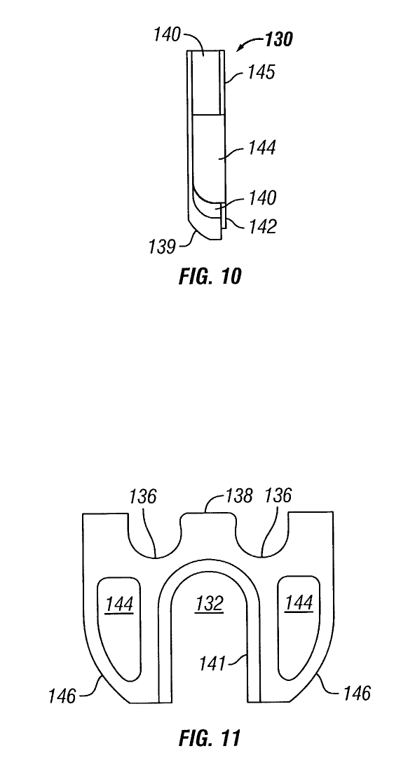

In a first alternative embodiment, a spacer 130, best shown in FIGS. 7-11, is likewise positioned between the outboard side of, preferably, the second rotating bevel gear 22 and the housing 11 as shown in FIG. 1, such that the second output shaft 26 passes through the slot 132 of the spacer 130. The spacer 130 is further provided with a pair of recesses 136 which define a finger grip 138 to facilitate installation and removal of the spacer 130 from the housing 11 during assembly/disassembly and repair. Additionally, the spacer 130 is provided with a radiused profile 139 along its lead edge to facilitate placing the spacer 130 between the second washer 34 and the housing 11 in the preferred embodiment. The gear-side (shown in FIG. 11) of the spacer 130 preferably is provided with a recess 141 along the periphery of the slot 132 to accommodate the second cylindrical bearing or washer 34. Preferably, the spacer 130 is further provided features to accommodate corresponding features within the interior of the housing 11. These features include a fillet 140 on each lateral side of the spacer 130 to accommodate screw bosses 23 within the housing 11. Additionally, the spacer 130 preferably includes first and second rabbets 142, 145 to prevent interference between any imperfections in the inner corners of the casting of the housing 11 and the spacer 30. To reduce the weight of the spacer 130, lightening holes 144 are preferably incorporated therein. Further, the outer periphery of the lead edge of the spacer 130 preferably is provided with a curvature 146 to accommodate the curvature of the inner surface of the housing 11. It should be noted that the outer surfaces of the spacer 130 are configured to play an important role in preventing the spacer from spinning freely in the housing 11 and also preventing the improper positioning of spacer 34 in the housing 11. The spacer 130 is, like the spacer 30 of the first preferred embodiment, retained within the housing 11 by its proximity to the cover 50, and more specifically, by the proximity between the contact surfaces 148 of the spacer 130 and the lands 56 of the cover 50, shown in FIGS. 5 and 6.

In a second alternative embodiment (not shown), the spacer 30 is retained within the housing 11 by a snap-type engagement between the spacer 30 and the housing 11 and by the cover-retention relationship discussed in the previous paragraph. In a third alternative embodiment (not shown), the spacer 30 is retained within the housing 11 by a snap-fit engagement with the second output shaft 26 and by the cover 50. As will be understood by those skilled in the art, the spacer 30 of the second alternative embodiment would preferably be constructed from a material which is moderately yieldable such that a protuberance (not shown) on the spacer 30 yields as it snaps into engagement with a receiving feature (not shown) on the housing 11. As will be understood by those skilled in the art, the spacer 30 of the third alternative embodiment also is preferably made from a moderately yieldable material such that the slot 32 may be enlarged slightly as one or more protuberances (not shown) on the inwardly-opposed surfaces of the slot 32 (which engage the second output shaft 26) pass over the second output shaft 26 during installation or removal of the spacer 30 from within the housing 11. Most preferably, the second and third alternative embodiments of the spacer 30 are made from PTFE, although other polymeric materials may be used. In addition, the spacer 30 could be designed as an integral part of the cover 50.

The differential gear drive system 10 is assembled within the housing 11 as follows, with reference primarily to FIG. 1. The input shaft/gear assembly (not shown) is positioned within the housing 11. The first output shaft 24 is positioned within the housing 11, the first cylindrical bearing or washer 28 is positioned on the first output shaft 24 and the locator cross pin is inserted through the hole in the inboard end of the first output shaft 24. The first rotatable bevel gear 20 is positioned on the inboard end of the first output shaft 24 such that the locator cross pin is received by the slot in the outboard or housing side of the first bevel gear 20. The first bevel gear 20 and first cylindrical bearing or washer 28 are moved into a position adjacent to the housing 11. The mounting shaft assembly is passed through each orbiting bevel gear 16, 18, and each mounting shaft assembly/bevel gear 16, 18 is positioned within a transverse passage through the primary helical gear 14. The assembly including the primary helical gear 14 engaging the input shaft/gear assembly and the orbiting bevel gears 16, 18 is positioned within the housing 11 such that the primary helical gear 14 and the orbiting bevel gears 16, 18 engage the first rotating bevel gear 20.

The second output shaft 26 is inserted into the housing 11 from the outboard side of the housing 11 such that the inboard end of the second output shaft 26 emerges slightly into the interior of the housing 11. The second cylindrical bearing or washer 34 is positioned on the second output shaft 26, followed by the second bevel gear 22. The second output shaft 26 is further inserted into the housing 11 such that the inboard end of the second output shaft 26 enters the central bore of the central support 15 of the primary helical gear 14. As the second output shaft 26 further enters the central bore of the primary helical gear 14, it becomes possible to insert the locator cross pin for the second rotatable bevel gear 22 into the hole through the second output shaft 26. Accordingly, the locator cross pin is inserted through the second output shaft 26 and the second output shaft 26 is slidably positioned fully into the housing 11 such that the locator cross pin is received in the slot in the outboard or housing side of the second bevel gear 22 and the second bevel gear 22 engages the orbiting bevel gears 16, 18. It should be noted that, as recognized by those skilled in the art, the sequence of the above events may be varied, depending upon several factors including the type of gears used, the configuration of the particular housing, and which of the first and second output shafts 24, 26 (or both shafts) are slidable along axis A-A to accommodate assembly space requirements.

The spacer 30 preferably is grasped by the finger grip 38 and placed into position within the housing 11, over the second output shaft 26 such that the second output shaft 26 is positioned within the slot 32. The spacer 30 is positioned between the housing 11 and the second cylindrical bearing or washer 34. Finally, the cover 50 is positioned over the opening in the housing 11 such that the contact surfaces 48 are proximate the lands 56, whereupon the fasteners (not shown) are passed through the non-threaded holes 54 and threaded into the threaded holes 27. It is also preferred that a gasket material (not shown) such as a silicone-based sealer or a rubber or fiber gasket is positioned between the cover 50 and the housing 11 to prevent leakage of lubricants out of the housing 11 or leakage of contaminants into the housing 11.

It should be noted that the above-described differential configuration is intended merely as exemplary and is not intended to be limiting. The above-described spacer 30, 130 and cover 50 for retaining the spacer 30, 130 is intended to have applicability in any gear drive system wherein the output shaft(s) must be fixed in position relative to a stationary surface within the cavity to complete assembly of the gear drive system.

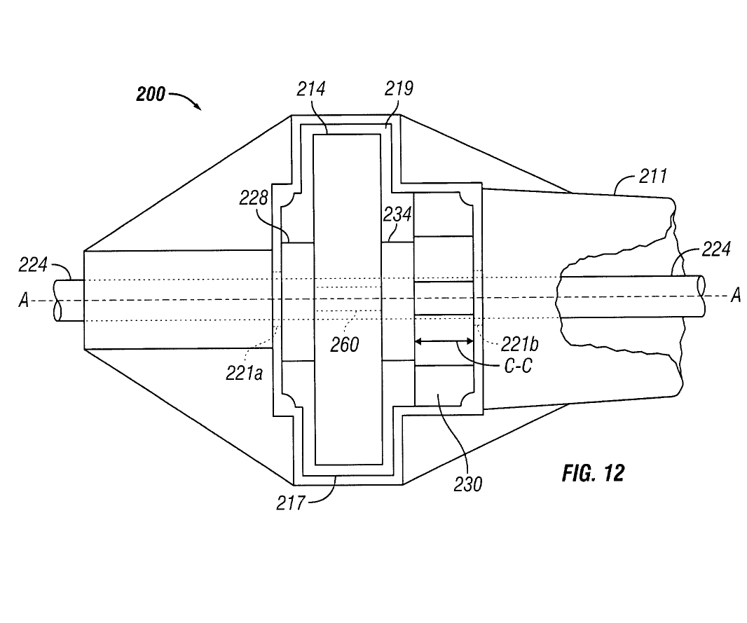

In a further embodiment of the present invention shown in FIG. 12, there is shown a non-differential gear drive system 200. For purposes of brevity, features shown in FIG. 12 that are common to FIG. 1 and are not necessary to the description of the present embodiment will not be described again. The housing 211 includes a cavity 219, a service port 217 in communication with the cavity 219, and a pair of opposed, axially aligned apertures 221a, 221b in communication with the cavity 219. A single output shaft 224 is positioned within the apertures 221a, 221b. The output shaft 224 is at least substantially aligned with the longitudinal axis A-A of the housing 211. A single drive gear 214 is fixedly positioned on the output shaft 224 such that the drive gear 214 is positioned within the cavity 219. A retainer 260, such as a key and keyway, is positioned on the output shaft 224 and drive gear 214, functioning to fixedly position the drive gear 214 on the output shaft 224. It is contemplated that other retainers (not shown) well known to those skilled in the art may be used to fix the drive gear 214 to the output shaft 224 without departing from the spirit and scope of the invention. To install the retainer 260 onto the drive gear 214 and output shaft 224 (described more fully below), the cavity 219 is provided with space sufficient to permit the retainer 260 to be inserted prior to properly positioning the drive gear 214 with respect to the output shaft 224 in the direction of the longitudinal axis A-A, as will be described more fully below.

Preferably, the non-differential gear drive system 200 further includes first and second circumferential bearings or washers 228, 234 adjacent to first and second sides of the drive gear 214. A third alternative embodiment of the spacer 230 is positioned proximate the service port 217, between the housing 211 and the drive gear 214, and more preferably between the housing 211 and the second circumferential bearing or washer 234. Preferably, the spacer 230 has the same features as shown in FIGS. 2-4, but as shown in FIG. 12 has a thickness C-C in the direction of the longitudinal axis A-A which preferably is greater than the thickness B-B of the first and second preferred embodiments shown in FIGS. 3 and 8. Alternatively, as a fourth alternative embodiment, the spacer 230 may be configured with the features shown in FIGS. 7-11, again preferably with a thickness C-C as shown in FIG. 12. As was described above with respect to the spacers 30, 130 as applied to a differential gear drive system, the spacer 230 is configured to preclude movement of the output shaft 224. In the present non-differential gear drive system 200, the spacer 230 acts to preclude movement of the output shaft 224 through at least substantially all of a predefined range of accessible travel. The predefined range of accessible travel is approximately the distance along the longitudinal axis A-A which is required to facilitate installation of the retainer 260. In FIG. 12, the predefined range of accessible travel is shown as being equal to the thickness C-C of the spacer 230. As will be recognized by those skilled in the art having read this disclosure, the cavity 219 must be configured to accommodate the predefined range of accessible travel of the output shaft 224.

Referring to FIGS. 5 and 6, a cover 50, as described above with regard to the differential gear drive system 10, is positioned over at least a portion of the service port 217 in the manner described above. The cover 50 includes a land 56 proximate the spacer 230 and retains the spacer 230 in position between the housing 211 and the drive gear 214.

The non-differential gear drive system 200 is assembled as follows. The drive gear 214 is inserted into the cavity 219 of the housing 211. The output shaft 224 is inserted into the housing 211 through one of the first and second apertures 221a, 221b, then through the other. As the output shaft 224 is slidably moved through the cavity 219, it is likewise inserted through a passage (not shown) in the first circumferential bearing or washer 228, through a passage (not shown) in the drive gear 214, and through a passage (not shown) in the second circumferential bearing or washer 234. Once the output shaft 224 is positioned in the housing 211, the second circumferential bearing or washer 234 is positioned adjacent the housing 211, distanced from the drive gear 214 by a distance approximately equal to the predefined range of travel, and the retainer 260 is positioned on the output shaft 224. The output shaft 224 is moved a distance approximately equal to the predefined range of accessible travel into place relative to the drive gear 214 such that the retainer 260 fixedly engages the drive gear 214 to the output shaft 224. For example, when the retainer 260 is a key/keyway, the output shaft 224 is preferably pressed into place with respect to the drive gear 214 with a hydraulic press. Those skilled in the art will recognize that the retainer 260 may include any number of commonly used mechanisms to secure a shaft to a gear without departing from the scope and spirit of the invention. The second circumferential bearing or washer 234 is positioned adjacent to the drive gear 214 and the spacer 230, having a thickness C-C approximately equal to the predefined range of accessible travel, is positioned on the output shaft 224, between the housing 211 and the second circumferential bearing or washer 234. It will be recognized by those skilled in the art having read this disclosure that the first and/or second circumferential bearings or washers 228, 234 may be omitted without departing from the spirit and scope of the invention. As discussed above with regard to the differential gear system 10, regardless of whether a second circumferential bearing or washer 234 is used, the spacer 230 will occupy a longitudinally oriented space along the output shaft 224 approximately equal to the predefined range of accessible travel and will therefore provide support in the direction of longitudinal axis A-A for properly positioning the drive gear 224 along that axis with respect to the housing 211 (and input drive/gear). Having installed the spacer 230, the cover 50 is positioned over at least a portion of the service port 217 such that the land 56 is proximate the spacer 230, retaining the spacer in position between the housing 211 and the second circumferential bearing or washer 234 (or drive gear 214, if no second circumferential bearing or washer 234 is used). Those skilled in the art will recognize that the order of the above-described steps may be varied from that which is stated above.

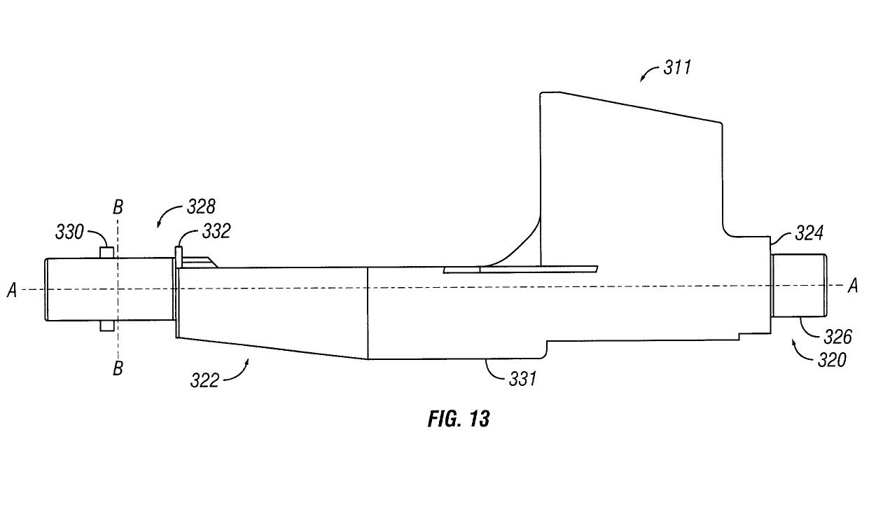

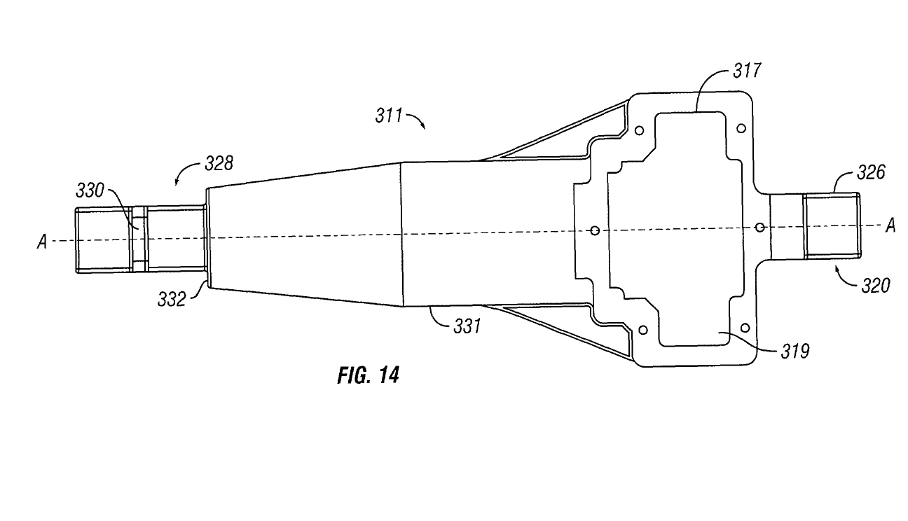

In still a further embodiment of the present invention, shown in FIGS. 13 and 14, there is shown an adaptable length housing 311 for a gear assembly. The housing 311 is intended for application in combination with either a differential gear assembly or a non-differential gear assembly, described in exemplary fashion hereinabove. The housing 311 preferably is made from A380 die cast aluminum, but other materials and forms of manufacture well known to those skilled in the art are contemplated.

The housing 311 includes a cavity 319 within which gears (more fully described above) are positioned and a service port 317 which provides access to the cavity 319 and, in the assembled state of the gear assembly, to the gears. The differential gear assembly 12 or drive gear 214 is positioned within the cavity 319, depending upon whether a differential or non-differential gear assembly is desired. The service port 317 provides access to the cavity 319 to facilitate assembly and service of the gear assembly. The housing 311 further includes first and second opposing shaft supports 320, 322 extending from either lateral portion of the cavity 319. In the context of the differential gear assembly described above, the first and second opposing shaft supports 320, 322 house and provide support for the first and second output shafts 24, 26 (see FIG. 1), respectively. When used in the context of a non-differential gear assembly, the first and second opposing shaft supports 320, 322 house and provide support for the output shaft 224 (see FIG. 12).

The first shaft support 320 includes a fixed position shoulder 324 to facilitate positioning the housing 311 in the vehicle. Preferably, the fixed position shoulder 324 is used as a reference point to determine the length of the housing 311 required for a particular vehicle, as discussed more fully below. The fixed position shoulder 324 preferably is integral with the housing 311 and with the first shaft support 320 so as to permit the fixed position shoulder 324 to be cast in place when the housing 311 is manufactured. It is contemplated that the fixed position shoulder 324 could also be a structure that is non-unitary with the housing 311, such as a bolt-on or slip-on structure (not shown). The distal or terminal portion of the first shaft support 320 includes a first housing mount 326, which preferably is square in a cross-sectional plane perpendicular to the longitudinal axis A-A of the housing 311. The first housing mount 326 may be attached to the vehicle in any number of conventional ways, including by bracket (not shown). It is contemplated that the first housing mount 326 need not be square but can be shaped to accommodate the mount structure of the vehicle.

The second shaft support 322 of the housing 311 includes adjacent its distal or terminal end an adaptive length mount 328 and an extension 331 between the cavity 319 and adaptive length mount 328. When the gear assembly is entirely assembled within the housing 311, the shaft(s) extend through the entire length of the housing 311 including the adaptive length mount 328, extension 331, cavity 319, and first housing mount 326.

The adaptive length mount 328 includes an outer shoulder 330 and an inner shoulder 332. The use of a plurality of shoulders 330, 332 on one end of the housing 311 permits the housing 311 to be adapted to various length requirements, the number of different housing lengths depending on the number of shoulders. In the embodiment of FIGS. 13-15, the housing 311 may be adapted to two lengths, one longer, one shorter. To employ the housing 311 where the longer configuration is required, the housing 311 is used in the form shown in FIGS. 13-15 with both shoulders 330, 332 present. In this configuration, the housing 311 being positioned relative to the outer shoulder 330 and the fixed position shoulder 324. To employ the housing 311 where the shorter configuration is required, the housing 311 is shortened by cutting the housing 311 along the line B-B with any conventional cutting mechanism such a cut-off saw. Thus, the housing 311 may be adapted to have application in any number of vehicles requiring a particular gear assembly merely by removing from the adaptive length mount 328 any number of portions of the mount 328 defined by shoulders. Note that when removing a portion of the adaptive length mount 328, the cut B-B preferably is made inboard of the shoulder to facilitate assembly of the gear assembly into the vehicle. It should be noted, however, that depending on the mounting configuration of a particular vehicle, the adaptive length mount 328 may be cut at any point along its length if the presence of a shoulder outboard of the cut will not impede mounting the gear assembly into the vehicle. Once the length of the housing 311 has been configured for a particular application, bearings, bushings, or the like preferably are positioned within bores in the first housing mount 326 and adaptive length mount 328 to support the shaft(s).

As with the first housing mount 326, the adaptive length mount 328 preferably is square in a cross-sectional plane perpendicular to the longitudinal axis A-A of the housing 311. Note, however, that the first housing mount 326 and adaptive length mount 328 may have virtually any cross-sectional shape, depending on the mounting configuration of the particular application. A shape that is square, or at the minimum, flat on a side in contact with the vehicle mount surface assists in resisting torque forces on the housing 311, thereby reducing or eliminating rotational movement of the housing 311 about its longitudinal axis A-A. Additionally, the outer and inner shoulders 330, 332 preferably extend in pairs from the adaptive length mount 328 in opposing directions but need not be pairs nor opposing, the need being defined by the application. Again, any number of shoulders may be included in the adaptive length mount 328, depending on the number of length variations desired.

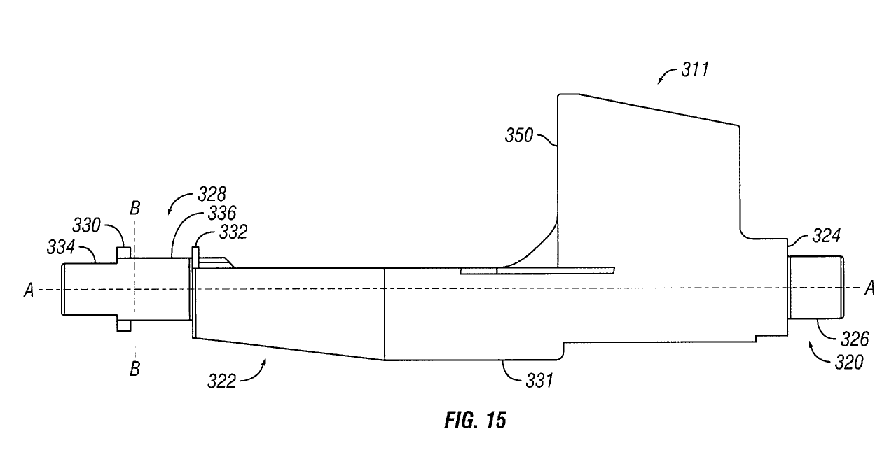

In an alternative embodiment, shown in FIG. 15, the adaptive length mount 328 may have various cross-sectional dimensions and shapes to suit different applications. Preferably, the adaptive length mount 328 has an outer portion 334 which is smaller than an inner portion 336. It is contemplated that the outer portion 334 and inner portion 336 of the adaptive length mount 328 may be varied depending on the mounting configuration required by the vehicles for which application is intended.

As shown in FIGS. 16-18, a further embodiment of the present invention is shown in relation to the exemplary differential gear assembly 12 of FIG. 1. Referring to FIGS. 16 and 17, and with further regard to FIGS. 1 and 13-15, the differential gear assembly 12 includes an input shaft/pinion gear 8 (“pinion 8”) operatively engaged with the teeth 14a of the primary helical gear 14. The pinion 8 is mounted in the cavity 319 and is supported adjacent its ends by a first bearing 338 and a second bearing 340. To prevent egress of lubricants (not shown) from the cavity 319 and likewise to prevent ingress of contaminants such as dirt, water, etc. into the cavity 319, a seal 342 is positioned within a bore 344 in the housing 311. When assembled in the housing 311, the pinion 8 passes through the seal 342 and the seal 342 creates a barrier to leakage and contamination.

A drive motor 352 mounts to a drive motor mounting surface 350 of the housing 311. The drive motor 352 includes a drive shaft 354 that projects from a face of the motor 352. The face of the motor 352 includes a cylindrical projection 356 that fits within a cylindrical depression 358 in the drive motor mounting surface 350. The drive shaft 354 is connected to the pinion 8 via a coupling 360. The drive motor 352 is positioned on and secured to the housing 311 after the seal 342 and second bearing 340 are installed. However, although the seal 342 and second bearing 340 preferably are press-fit and therefore will remain in place under normal operating conditions, it is desirable to ensure that the bearing 340 and seal 342 will not, due to thermal effects, vibration, and the like, move from their proper positions and permit the pinion 8 to move through other than its predetermined range of motion, thus shortening the useful life of the gear assembly 12. Toward this end, an axial spacer 346 is positioned within a bore 348 adjacent to the drive motor mounting surface 350 of the housing 311. The axial spacer 346 has a slip fit within the bore 348 of the housing 311 and is installed into the bore 348 after installation of the second bearing 340 and seal 342 and prior to installation of the drive motor 352. The inboard end of the axial spacer 346 preferably seats against at least a portion of the outboard side of seal 342 and the outboard side of the axial spacer 346 preferably is in mating contact with the drive motor 352 upon installation of the motor 352, thereby maintaining the second bearing 340 and seal 342 in place. Referring to FIG. 18, the axial spacer 346 preferably includes a seat 346a for abutting the seal 342. The seat 346a includes a passage 346c sized for receiving but not contacting the shaft 354 of the drive motor 352. Attached to the seat 346a is a cylindrical tube 346b which, as stated above, is sized so as to provide contact between the drive motor 352 and the seal 342. Preferably the axial spacer 346 is unitary and is constructed from steel, but other materials may be used without departing from the scope and spirit of the invention.

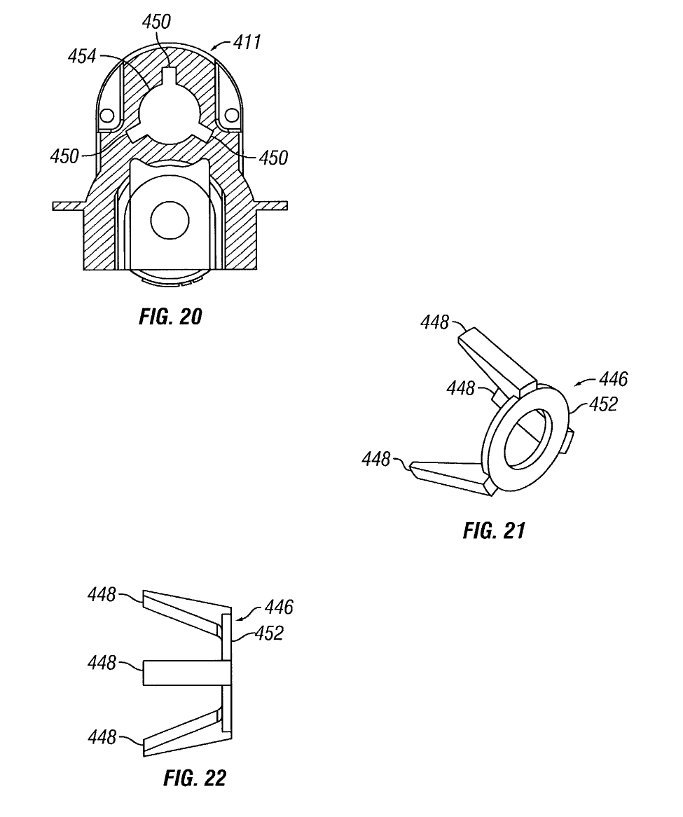

Referring now to FIGS. 19-22, there is shown an alternative configuration of the axial spacer 346, designated in this embodiment as reference number 446. FIG. 19 shows a portion of a housing 411, modified from that shown in FIGS. 13-16 insofar as the bore 348, which accepts the axial spacer 346, is configured as a bore 454 to accommodate the shape of the axial spacer 446. The axial spacer 446 performs the same function as the axial spacer 346, but has a physical configuration that maintains the axial spacer 446 in registry with the housing 411 so as to preclude the axial spacer 446 from rotating within the housing 411. In this regard, the axial spacer 446 includes a plurality of legs 448 that each are positioned within a channel 450 of the bore 454 when the axial spacer 446 is in position between the drive motor 352 and the seal 342 (shown in FIGS. 16, 17). The axial spacer 446 further includes a circumferential seat 452 to which each of the plurality of legs 448 are attached and which preferably is unitary with the legs 448. The legs 448 extend radially beyond the outer radial surface of the seat 452 so as to prevent the axial spacer 446 from rotating with respect to the longitudinal axis of the drive motor shaft 354 (FIGS. 16, 17). Therefore, when the axial spacer 446 is positioned within the housing 411, the seat 452 is positioned within the bore 454 of the housing 411 and the legs 448 extend radially outwardly into the channels 450. It should be understood that any number of legs 448 may be used and the seat 452 need not be circumferential, so long as the axial spacer 446 maintains the second bearing 340 and seal 342 (FIGS. 16, 17) in position and does not rotate within the housing 411. Additionally, although it is preferred that the axial spacer 446 be made of steel, any hard, durable material will suffice.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1. A gear drive assembly comprising:
an elongated housing having a cavity and a pair of opposed apertures in communication with the cavity, the apertures being aligned with a longitudinal axis of the housing;
an output shaft extending through the apertures;
a drive gear positioned in the cavity and fixedly connected to the output shaft for rotation therewith, the drive gear and the output shaft having a predefined range of travel in a direction of the longitudinal axis to facilitate assembly of the gear drive assembly; and
a spacer located within the cavity between the housing and the drive gear, the spacer being configured to preclude movement of the drive gear and the output shaft through at least substantially all of the predefined range of travel.

2. A gear drive assembly according to claim 1, wherein the spacer comprises a pair of spaced legs with a slot therebetween, the output shaft being received within the slot.

3. A gear drive assembly according to claim 2, wherein the housing comprises a service port adjacent the drive gear and the spacer, and a cover that covers at least a portion of the service port.

4. A gear drive assembly according to claim 3, wherein the cover has an inner surface that is at least proximate the spacer for retaining the spacer in position on the output shaft between the housing and the drive gear.

5. A gear drive assembly according to claim 4, wherein the cavity is formed with at least one of a projection and a depression, and further wherein the spacer is formed with at least one of a corresponding depression and projection for receiving the at least one of a projection and depression, respectively, of the cavity.

6. A gear drive assembly according to claim 5, and further comprising a bearing mounted on the output shaft between the spacer and the drive gear, and further wherein the spacer has a recess that receives at least a portion of the bearing.

7. A gear drive assembly according to claim 1, wherein the cavity is formed with at least one of a projection and a depression, and further wherein the spacer is formed with at least one of a corresponding depression and projection for receiving the at least one of a projection and depression, respectively, of the cavity.

8. A gear drive assembly according to claim 1, and further comprising a bearing mounted on the output shaft between the spacer and the drive gear, and further wherein the spacer has a recess that receives at least a portion of the bearing.

9. A gear drive assembly according to claim 1, and further comprising a drive motor mounted on the housing and operably connected to the drive gear for transferring power from the drive motor to the output shaft.

10. A gear drive assembly according to claim 9, wherein the drive motor has a drive shaft, and further comprising a bearing and seal assembly mounted in the housing around the drive shaft.

11. A gear drive assembly according to claim 10, and further comprising an axial spacer located between, and in contact with, the drive motor and the bearing and seal assembly to thereby prevent movement of the bearing and seal assembly.

12. A gear drive assembly according to claim 11, wherein the axial spacer is positioned within a bore of the housing and coaxial with the drive shaft.

13. A gear drive assembly according to claim 11, wherein the axial spacer includes an annular seat portion that abuts the bearing and seal assembly and a cylindrical tube portion extending from the seat portion that abuts the drive motor.

14. A gear drive assembly according to claim 11, wherein the axial spacer includes an annular seat portion that abuts the bearing and seal assembly and leg portions that abut the drive motor.

15. A gear drive assembly according to claim 14, wherein the axial spacer is positioned within a bore of the housing and coaxial with the drive shaft.

16. A gear drive assembly according to claim 15, wherein the bore of the housing includes channels into which the leg portions are received.

17. A gear drive assembly according to claim 1, and further comprising a variable length mount located at a longitudinal end of the housing which may be shortened to accommodate various mounting criteria of a vehicle.

18. A gear drive assembly according to claim 17, wherein the variable length mount comprises a first shoulder connected to the longitudinal end of the housing and an inner portion extending from the first shoulder along the longitudinal axis for mounting engagement with a vehicle.

19. A gear drive assembly according to claim 18, wherein the variable length mount further comprises a second shoulder connected to a longitudinal end of the inner portion and an outer portion extending from the second shoulder for mounting engagement with a vehicle.

20. A gear drive assembly according to claim 19, wherein the second shoulder and outer portion are separable from the inner portion to thereby shorten the variable length mount.

21. A gear drive assembly comprising:
an elongated housing having a cavity and a pair of opposed apertures in communication with the cavity, the apertures being aligned with a longitudinal axis of the housing;
at least one output shaft extending through the apertures;
a drive gear positioned in the cavity and fixedly connected to the at least one output shaft for rotation therewith;
a drive motor mounted on the housing and operably connected to the at least one gear for transferring power from the drive motor to the at least one output shaft, the drive motor including a drive shaft;
a bearing and seal assembly mounted in the housing around the drive shaft; and
an axial spacer located between, and in contact with, the drive motor and the bearing and seal assembly to thereby prevent movement of the bearing and seal assembly.

22. A gear drive assembly according to claim 21, wherein the axial spacer is positioned within a bore of the housing and coaxial with the drive shaft.

23. A gear drive assembly according to claim 21, wherein the axial spacer includes an annular seat portion that abuts the bearing and seal assembly and a cylindrical tube portion extending from the seat portion that abuts the drive motor.

24. A gear drive assembly according to claim 21, wherein the axial spacer includes an annular seat portion that abuts the bearing and seal assembly and leg portions that abut the drive motor.

25. A gear drive assembly according to claim 24, wherein the axial spacer is positioned within a bore of the housing and coaxial with the drive shaft.

26. A gear drive assembly according to claim 25, wherein the bore of the housing includes channels into which the leg portions are received.

27. A housing for a gear drive assembly, the housing comprising:
a bottom wall extending along a longitudinal axis;
a pair of opposing side walls extending from the bottom wall along the longitudinal axis;
a top wall opposite the bottom wall and connected to the pair of opposing side walls along the longitudinal axis;
a pair of opposing end walls extending between the top, bottom and side walls generally transverse to the longitudinal axis, the bottom, side, top, and end walls forming an internal cavity into which a gear drive assembly can be received; and
an aperture formed in each end wall in alignment with the longitudinal axis, the apertures being adapted for receiving at least one shaft of the gear drive assembly;
wherein at least one of the end walls is variable in position along the longitudinal axis to accommodate various mounting criteria of a vehicle.

28. A housing for a gear drive assembly according to claim 27, wherein the variable length mount comprises a first shoulder connected to the longitudinal end of the housing and an inner portion extending from the first shoulder along the longitudinal axis for mounting engagement with a vehicle.

29. A housing for a gear drive assembly according to claim 28, wherein the variable length mount further comprises a second shoulder connected to a longitudinal end of the inner portion and an outer portion extending from the second shoulder for mounting engagement with a vehicle.

30. A housing for a gear drive assembly according to claim 29, wherein the second shoulder and outer portion are separable from the inner portion to thereby shorten the variable length mount.
